(19) United States
(12) Patent Application Publication
(10) Pub. No.: US 2004/0181545 A1
(43) Pub. Date: Sep. 16, 2004

(54) Generating and rendering annotated video files

(76) Inventors: Yining Deng, Sunnyvale, CA (US); Tong Zhang, San Jose, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/386,217

(22) Filed: Mar. 10, 2003

(51) Int. Cl. G06F 17/00

(52) U.S. Cl. 707/103 R

(57) ABSTRACT

Systems and methods of generating and rendering annotated video files are described. In one aspect, an original video file is annotated by embedding therein information enabling rendering of at least one video summary that is contained in the annotated video file and comprises digital content summarizing at least a portion of the original video file. In another aspect, a system for rendering an annotated video file includes a video rendering engine that is operable to identify information that is embedded in the annotated video file and enables rendering of at least one video summary that is contained in the annotated video file and comprises digital content summarizing at least a sequence of video frames contained in the video file. The video rendering engine is operable to render the at least one video summary.

### TECHNICAL FIELD

This invention relates to systems and methods of generating and rendering annotated video files.

### BACKGROUND

Individuals and organizations are rapidly accumulating large collections of video content. As these collections grow, individuals and organizations increasingly will require systems and methods for organizing and summarizing the video content in their collections so that desired video content may be found quickly and easily. To meet this need, a variety of different systems and methods for creating and summarizing video content have been proposed.

For example, storyboard summarization has been developed to enable full-motion video content to be browsed. In accordance with this technique, video information is condensed into meaningful representative snapshots and corresponding audio content. One known video browser of this type divides a video sequence into equal length segments and denotes the first frame of each segment as its key frame. Another known video browser of this type stacks every frame of the sequence and provides the user with information regarding the camera and object motions.

Content-based video summarization techniques also have been proposed. In these techniques, a long video sequence typically is classified into story units based on video content. In some approaches, scene change detection (also called temporal segmentation of video) is used to give an indication of when a new shot starts and ends. Scene change detection algorithms, such as scene transition detection algorithms based on DCT (Discrete Cosine Transform) coefficients of an encoded image, and algorithms that are configured to identify both abrupt and gradual scene transitions using the DCT coefficients of an encoded video sequence are known in the art.

In one video summarization approach, Rframes (representative frames) are used to organize the visual contents of video clips. Rframes may be grouped according to various criteria to aid the user in identifying the desired material. In this approach, the user may select a key frame, and the system then uses various criteria to search for similar key frames and present them to the user as a group. The user may search representative frames from the groups, rather than the complete set of key frames, to identify scenes of interest. Language-based models have been used to match incoming video sequences with the expected grammatical elements of a news broadcast. In addition, a priori models of the expected content of a video clip have been used to parse the clip.

In another approach, a hierarchical decomposition of a complex video selection is extracted for video browsing purposes. This technique combines visual and temporal information to capture the important relations within a scene and between scenes in a video, thus allowing the analysis of the underlying story structure with no a priori knowledge of the content. A general model of a hierarchical scene transition graph is applied to an implementation for browsing. Video shots are first identified and a collection of key frames is used to represent each video segment. These collections then are classified according to gross visual information. A platform is built on which the video is presented as directed graphs to the user, with each category of video shots represented by a node and each edge denoting a temporal relationship between categories. The analysis and processing of video is carried out directly on the compressed videos.

In each of the above-described video summarization approaches, the video summary information is stored separately from the original video content. Consequently, in these approaches there is risk that information enabling video summaries to be rendered may become disassociated from the corresponding original video files when the original video files are transmitted from one video rendering system to another.

### SUMMARY

The invention features systems and methods of generating and rendering annotated video files.

In one aspect, the invention features a method of generating an annotated video file. In accordance with this inventive method, an original video file is annotated by embedding therein information enabling rendering of at least one video summary that is contained in the annotated video file and comprises digital content summarizing at least a portion of the original video file.

In another aspect, the invention features a computer program for implementing the above-described annotated video file generation method.

Another aspect of the invention features a computer-readable medium tangibly storing an annotated video file having embedded therein information enabling rendering of at least one video summary that is contained in the annotated video file and comprises digital content summarizing at least a portion of an original video file.

In another aspect, the invention features a system for rendering an annotated video file that includes a video rendering engine. The video rendering engine is operable to identify information that is embedded in the annotated video file and enables rendering of at least one video summary that is contained in the annotated video file and comprises digital content summarizing at least a sequence of video frames contained in the video file. The video rendering engine is operable to render the at least one video summary.

Other features and advantages of the invention will become apparent from the following description, including the drawings and the claims.

### DESCRIPTION OF DRAWINGS

FIG. 1 is a block diagram of a system for generating and rendering annotated video files.

FIG. 2 is a flow diagram of an embodiment of a method of generating an annotated video file.

FIG. 3A is a diagrammatic view of video summary rendering information embedded in a header of a video file.

FIG. 3B is a diagrammatic view of video summary rendering information embedded at different locations in a video file.

FIG. 4 is a diagrammatic view of a video file segmented into shots and multiple keyframes identified in the video file and organized into a two-level browsing hierarchy.

FIG. 5 is a diagrammatic view of video summary rendering information.

FIG. 6 is a flow diagram of an embodiment of a method of rendering an annotated video file.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

The embodiments described below feature systems and methods of generating annotated video files from original video files, which may or may not have been previously annotated. The annotated video files include embedded information enabling the rendering of at least one video summary that is contained in the annotated video file and includes digital content summarizing at least a portion of the original video file. In this way, the video summaries are is always accessible to a rendering system because the resulting annotated video files contain the contents of both the original video file and the video summaries. Users may therefore quickly and efficiently browse through a collection of annotated video files without risk that the video summaries will become disassociated from the corresponding video files, regardless of the way in which the video files are transmitted from one rendering system to another.

As used herein, “video summary” refers to any digital content that summarizes (i.e., represents, symbolizes, or brings to mind) the content of an associated sequence of video frames of an original video file. The digital content of a video summary may be in the form of one or more of text, audio, graphics, animated graphics, and full-motion video. For example, in some implementations, a video summary may include one or more images representative of original video file content and digital audio content synchronized to the one or more representative images.

I. System Overview

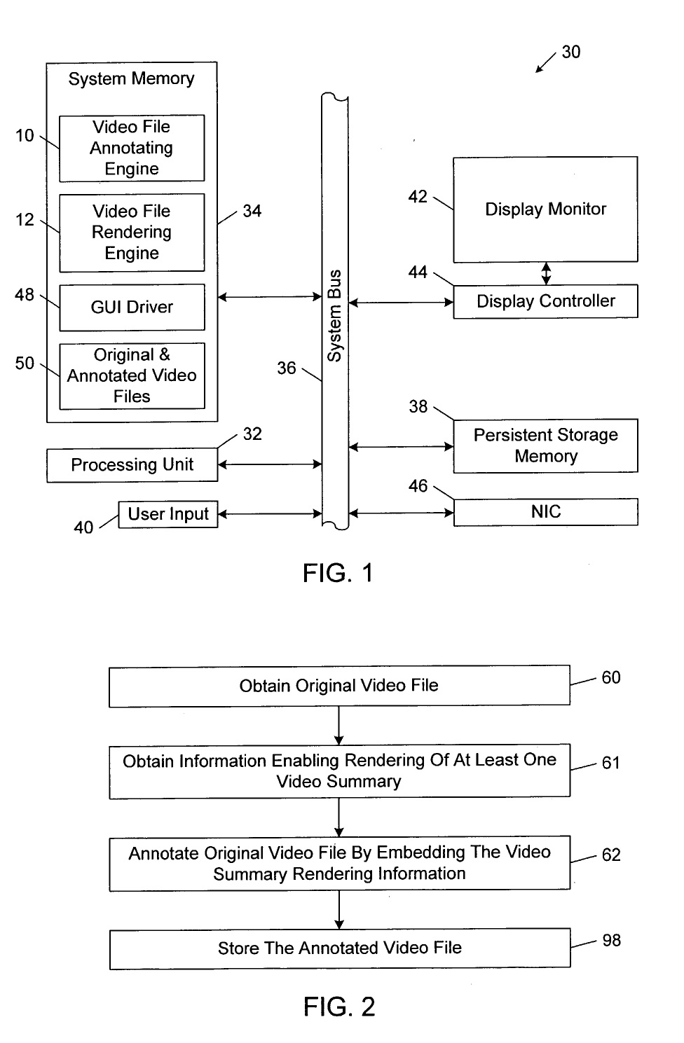

Referring to FIG. 1, in one embodiment, a system for generating and rendering annotated video files includes a video file annotating engine 10 and a video file rendering engine 12. Both of these engines may be configured to operate on any suitable electronic device, including a computer (e.g., desktop, laptop and handheld computer), a video camera, or any other suitable video capturing, video editing, or video viewing system (e.g., an entertainment box, such as a video recorder or player, which is connected to a television).

In a computer-based implementation, both video file annotating engine 10 and video file rendering engine 12 may be implemented as one or more respective software modules operating on a computer 30. Computer 30 includes a processing unit 32, a system memory 34, and a system bus 36 that couples processing unit 32 to the various components of computer 30. Processing unit 32 may include one or more processors, each of which may be in the form of any one of various commercially available processors. System memory 34 may include a read only memory (ROM) that stores a basic input/output system (BIOS) containing start-up routines for computer 30 and a random access memory (RAM). System bus 36 may be a memory bus, a peripheral bus or a local bus, and may be compatible with any of a variety of bus protocols, including PCI, VESA, Microchannel, ISA, and EISA. Computer 30 also includes a persistent storage memory 38 (e.g., a hard drive, a floppy drive 126, a CD ROM drive, magnetic tape drives, flash memory devices, and digital video disks) that is connected to system bus 36 and contains one or more computer-readable media disks that provide non-volatile or persistent storage for data, data structures and computer-executable instructions. A user may interact (e.g., enter commands or data) with computer 30 using one or more input devices 40 (e.g., a keyboard, a computer mouse, a microphone, joystick, and touch pad). Information may be presented through a graphical user interface (GUI) that is displayed to the user on a display monitor 42, which is controlled by a display controller 44. Computer 30 also may include peripheral output devices, such as speakers and a printer. One or more remote computers may be connected to computer 30 through a network interface card (NIC) 46.

As shown in FIG. 1, system memory 34 also stores video file annotating engine 10, video rendering engine 12, a GUI driver 48, and one or more original and annotated video files 50. In some implementations, video file annotating engine 10 interfaces with the GUI driver 48, the original video files, and the user input 40 to control the generation and rendering of annotated video files. Video file rendering engine 12 interfaces with the GUI driver 48 and the annotated video files to control the video browsing and rendering experience presented to the user on display monitor 42. The original and annotated video files in the collection to be rendered and browsed may be stored locally in persistent storage memory 38 or stored remotely and accessed through NIC 46, or both.

II. Generating Annotated Video Files

Referring to FIG. 2, in some embodiments, an annotated video file may be generated as follows. Video file annotating engine 10 obtains an original video file (step 60). The original video file may correspond to any compressed (e.g., MPEG or Motion JPEG) or uncompressed digital video file, including video clips, home movies, and commercial movies. Video file annotating engine 10 also obtains information that enables at least one video summary to be rendered (step 61). Video file annotating engine 10 annotates the original video file by embedding the video summary rendering information in the original video file (step 62).

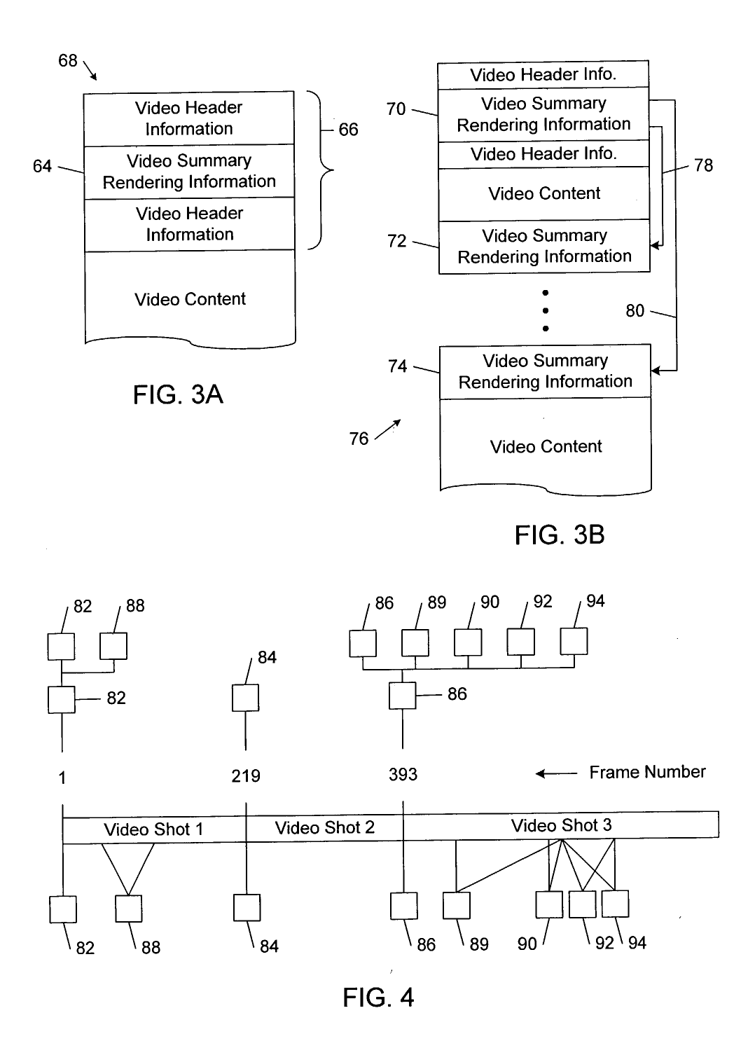

Referring to FIGS. 3A and 3B, in some embodiments, video summary rendering information 64 is embedded in the header 66 of an original video file 68 (FIG. 3A). In other embodiments, video summary rendering information 70, 72, 74 is embedded at different respective locations (e.g., locations preceding each shot) of an original video file 76 separated by video content of the original video file 76 (FIG. 3B). In some of these embodiments, pointers 78, 80 to the locations of the other video summary rendering information 72, 74 may be embedded in the header of the original video file 76, as shown in FIG. 3B.

In some implementations, the video summary rendering information that is embedded in the original video file corresponds to the video summary itself. As mentioned above, a video summary is any digital content (e.g., text, audio, graphics, animated graphics, and full-motion video) that summarizes (i.e., represents, symbolizes, or brings to mind) the content of the associated sequence of video frames of the original video file. Accordingly, in these implementations, the digital content of the video summaries are embedded in the original video files. In some implementations, a video summary may be derived from the original video file (e.g., keyframes of the original video file, short segments of the original video file, or an audio clip from the original video file). In other implementations, a video summary may be obtained from sources other than the original video file yet still be representative of the original video file (e.g., a trailer of a commercial motion picture, an audio or video clip, or a textual description of the original video).

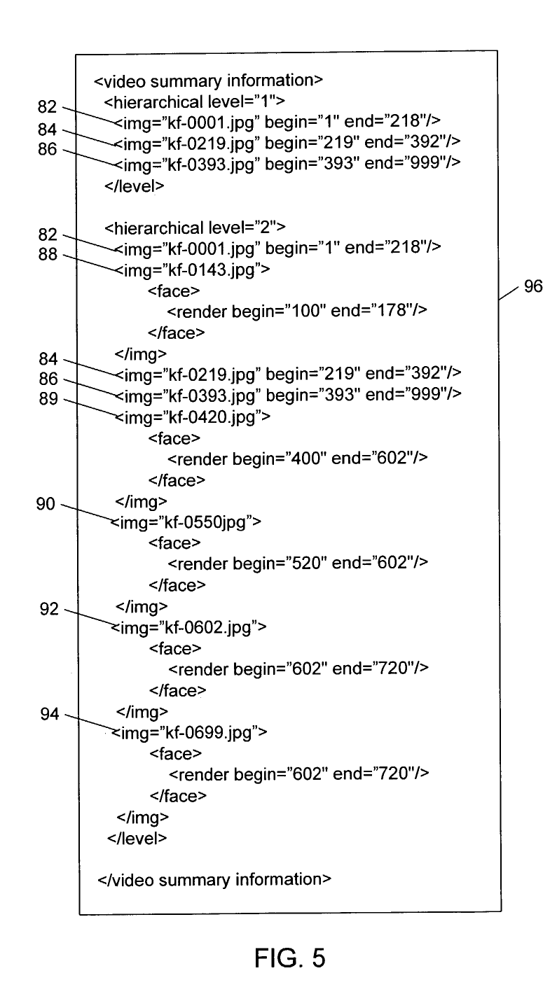

Referring to FIGS. 4 and 5, in some embodiments, a video summary may be derived automatically from the original video file based on an analysis of the contents of the original video file. For example, in some implementations, video file annotating engine 10 may perform shot boundary detection, keyframe selection, and face detection and tracking using known video processing techniques. Shot boundary detection is used to identify discontinuities between different shots (e.g., shots 1, 2, 3 in FIG. 4), each of which corresponds to a sequence of frames that is recorded contiguously and represents a continuing action in time and space. Keyframe selection involves selecting keyframes that represent the content of each shot. In some implementations, the first frame in each shot that passes an image blur test is selected as a representative keyframe (e.g., keyframes 82, 84, 86 corresponding to frame numbers 1, 219, 393). In addition to the first frames of each shot, frames containing detected faces (e.g., frames 88, 89, 90, 92, 94) also are selected as representative keyframes; the selected frames may correspond to the first substantially blur-free frame in a contiguous sequence of frames in a shot containing the same face. Face tracking is used to associate frames containing the same person within a continuous video shot.

In some embodiments, the keyframes of each shot are organized into a hierarchy to allow a user to browse video summaries at multiple levels of detail. For example, in the illustrated embodiment, the first level of detail corresponds to the first keyframes 82, 84, 86 of each shot. The next level of detail corresponds to all of the keyframes of each shot arranged in chronological order. Other known hierarchical representations also may be used.

Referring to FIG. 5, in some embodiments, the video summary rendering information that is embedded in the original video file corresponds to pointers to frames of the original video file. In the illustrated embodiment, the pointers correspond to keyframe numbers of the representative keyframes that are identified by the automatic summarization process described above in connection with FIG. 4. In other embodiments, the pointers may correspond to rendering (or playback) times. In the illustrated embodiments, the pointers and hierarchical information are stored in an XML (extensible Markup Language) data structure 96 that may be embedded in the header or other location of the original video file. In hierarchical level 1 of data structure 96, keyframes 82, 84, 86 (see FIG. 4) respectively correspond to images kf-001.jpg, kf-0219.jpg, kf-0393.jpg. In hierarchical level 2, keyframes 82, 84, 86 correspond to images kf-001.jpg, kf-0219.jpg, kf-0393.jpg, respectively, as before; in addition, keyframes 88, 89, 90, 92, 94 (see FIG. 4) respectively correspond to images kf-0143.jpg, kf-0420.jpg, kf-0550.jpg, kf-0602.jpg, kf-0699.jpg. As explained above, each of keyframes 88, 89, 90, 92, 94 corresponds to images containing one or more detected faces. The video frame number range of each keyframe image is specified by respective “begin” and “end” tags.

Referring back to FIG. 2, after the video file has been annotated, video file annotating engine 10 stores the annotated video file (step 98). For example, the annotated video file may be stored in persistent storage memory 38 (FIG. 1).

III. Rendering Annotated Video Files

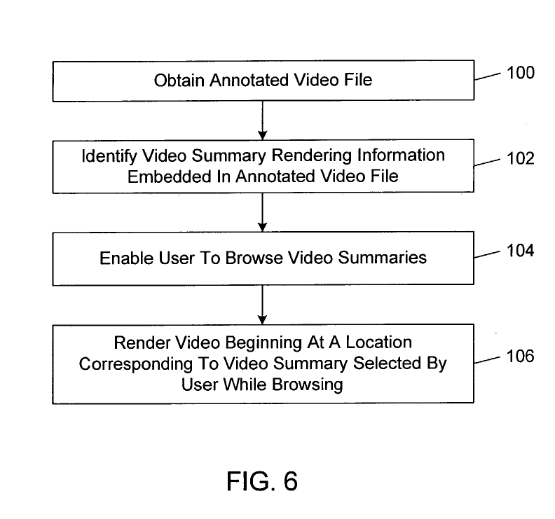

Referring to FIG. 6, in some embodiments, an annotated video file may be rendered by video file rendering engine 12 as follows. Video file rendering engine 12 obtains a video file that has been annotated in one or more of the ways described above (step 100). Video file rendering engine 12 identifies video summary rendering information that is embedded in the annotated video file (step 102). As explained above, the video summary rendering information may correspond to one or more video summaries that are embedded in the header or in other locations of the annotated video file. Alternatively, the video summary rendering information may correspond to one or more pointers to locations where respective video summaries are embedded in the annotated video file. Based on the video summary rendering information, video file rendering engine 12 enables a user to browse the summaries embedded in the annotated video file (step 104). Video file rendering engine 12 initially may render video summaries at the lowest (i.e., most coarse) level of detail. For example, in some implementations, video file rendering engine 12 initially may present to the user the first keyframe of each shot. If the user requests summaries to be presented at a greater level of detail, video file rendering engine 12 may render the video summaries at a greater level of detail (e.g., render all of the keyframes of each shot).

In some implementations, while the user is browsing video summaries, the user may select a particular summary (e.g., keyframe) as corresponding to the starting point for rendering the original video file. In response, video file rendering engine 12 renders the original video file beginning at the point corresponding to the video summary selected by the user (step 106).

IV. Conclusion

Other embodiments are within the scope of the claims.

The systems and methods described herein are not limited to any particular hardware or software configuration, but rather they may be implemented in any computing or processing environment, including in digital electronic circuitry or in computer hardware, firmware, or software.

What is claimed is:

1. A method of generating an annotated video file, comprising:
annotating an original video file by embedding therein information enabling rendering of at least one video summary contained in the annotated video file and comprising digital content summarizing at least a portion of the original video file.

2. The method of claim 1, wherein the rendering enabling information is embedded in a header of the video file.

3. The method of claim 2, wherein rendering enabling information includes a video summary embedded in the video file header.

4. The method of claim 2, wherein rendering enabling information embedded in the video file header includes one or more pointers to one or more respective frames of the original video file.

5. The method of claim 1, wherein rendering enabling information is embedded at different locations in the annotated video file separated by video content of the original video file.

6. The method of claim 5, wherein rendering enabling information includes video summaries embedded at different respective locations in the annotated video file separated by video content of the original video file.

7. The method of claim 5, wherein rendering enabling information includes pointers to frames of the original video file, the pointers being embedded at different respective locations in the annotated video file separated by video content of the original video file.

8. The method of claim 1, wherein rendering enabling information includes hierarchical information enabling rendering of video summaries at different levels of detail.

9. The method of claim 1, wherein at least one video summary corresponds to one or more keyframes identified in the original video file.

10. The method of claim 9, wherein at least one keyframe corresponds to a video frame of the original video file representative of a segment of the original video file.

11. The method of claim 9, wherein at least one keyframe corresponds to a frame of the original video file containing a person's face.

12. The method of claim 1, wherein at least one video summary corresponds to a sequence of video frames.

13. The method of claim 12, wherein the sequence of video frames corresponds to a video frame sequence of the original video file.

14. The method of claim 12, wherein the sequence of video frames corresponds to a video frame sequence not contained in the original video file.

15. The method of claim 1, wherein at least one video summary corresponds to digital audio content.

16. The method of claim 1, wherein at least one video summary corresponds to one or more images representative of original video file content and digital audio content synchronized to the one or more representative images.

17. The method of claim 1, wherein at least one video summary corresponds to digital textual content.

18. A software program for generating an annotated video file, the software program residing on a medium readable by an electronic device and comprising instructions for causing an electronic device to:
annotate an original video file by embedding therein information enabling rendering of at least one video summary contained in the annotated video file and comprising digital content summarizing at least a portion of the original video file.

19. A medium readable by an electronic device and tangibly storing an annotated video file having embedded therein information enabling rendering of at least one video summary contained in the annotated video file and comprising digital content summarizing at least a portion of an original video file.

20. A system for rendering an annotated video file, comprising:
a video rendering engine operable to identify information embedded in the annotated video file and enabling rendering of at least one video summary contained in the annotated video file and comprising digital content summarizing at least a sequence of video frames contained in the video file, and to operable to render the at least one video summary.

21. The system of claim 20, wherein the video rendering engine is operable to render at least one video summary embedded in the annotated video file.

22. The system of claim 21, wherein at least one video summary corresponds to one or more keyframes identified in the original video file.

23. The system of claim 21, wherein at least one video summary corresponds to a sequence of video frames.

24. The system of claim 21, wherein at least one video summary corresponds to digital audio content.

25. The system of claim 21, wherein at least one video summary corresponds to one or more images representative of original video file content and digital audio content synchronized to the one or more representative images.

26. The system of claim 21, wherein at least one video summary corresponds to digital textual content.

27. The system of claim 20, wherein the video rendering engine is operable to render one or more frames of the video frame sequence based on at least one pointer to a respective frame of the vide frame sequence, the at least one pointer being embedded in the annotated video file.

28. The system of claim 20, wherein the rendering enabling information includes hierarchical information, and the video rendering engine is operable to render video summaries at different levels of detail based on the hierarchical information.

29. The system of claim 20, wherein the video rendering engine is operable to render a sequence of video frames contained in the annotated video file based on a video summary selected by a user.
